(19) United States
(12) Patent Application Publication
(10) Pub. No.: US 2009/0015865 A1
(43) Pub. Date: Jan. 15, 2009

(54) Image forming apparatus and computer readable recording medium

(75) Inventors: Kozo Tao, Osaka (JP); Takashi Murakami, Osaka (JP)

Correspondence Address: VON SIMSON & CHIN, 62 WILLIAM STREET, 6TH FLOOR, NEW YORK, NY, 10005, US

(73) Assignee: Kyocera Mita Corporation

(21) Appl. No.: 12/171,689

(22) Filed: Jul. 11, 2008

(30) Foreign Application Priority Data
Jul. 12, 2007 (JP) 2007-182872

(51) Int. Cl. G06F 3/12

(52) U.S. Cl. 358/1.15

(57) ABSTRACT

An image forming apparatus according to an aspect of the present invention includes (a) a print engine that performs secondary paper feed after primary paper feed, and generates an image based on image data and then transfers and fixes the image on a paper after the secondary paper feed, (b) a print job receiving unit that receives a print job and causes the print engine to start the primary paper feed and (c) an image forming unit that forms the image data based on the print job and outputs the image data to the print engine, and causes the print engine to start generating the image prior to the secondary paper feed after the primary paper feed.

### CROSS-REFERENCE TO RELATED APPLICATIONS

This application relates to and claims priority rights from Japanese Patent Application Nos. 2007-182872, filed on Jul. 12, 2007 the entire disclosure of which is hereby incorporated by reference herein.

### BACKGROUND OF THE INVENTION

1. Field of the Invention

This invention relates to image forming apparatus and computer readable recording medium.

2. Description of the Related Art

When a print process is executed in a printer or the like, the print process is controlled along the following sequence; a data receiving unit receives print data transmitted from a host computer and requests to an image forming unit to form image data, and upon the request, the image forming unit forms image data and requests to start paper feed to a print engine, and then the print engine transports a paper from a paper drawer to a resist roller in primary paper feed, fixes a toner image on the paper after secondary paper feed, and outputs the paper after the fix process.

In a printer or the like, in order to speed-up the print process, in a technique shown in FIG. 3, while a document is being read (i.e. a print job is being received), a request of starting primary paper feed or an image forming request is supplied to perform primary paper feed in advance, and consequently primary paper feed is performed soon.

### SUMMARY OF THE INVENTION

According to the technique mentioned above, in an image forming apparatus, primary paper feed can be started while a document is being read to speed-up copy process. However, when an image forming apparatus works as a printer, printing time is sometimes not reduced even if primary paper feed is performed soon, since the size of a print job to be received may be small or large.

This invention was conceived to overcome the problem mentioned above. An object of this invention is to provide an image forming apparatus and a computer readable recording medium storing an image forming program that are capable of reducing printing time in a printer function.

In order to solve such subject, an image forming apparatus according to an aspect of the present invention includes (a) a print engine that performs secondary paper feed after primary paper feed, and generates an image based on image data and then transfers and fixes the image on a paper after the secondary paper feed, (b) a print job receiving unit that receives a print job and causes the print engine to start the primary paper feed and (c) an image forming unit that forms the image data based on the print job and outputs the image data to the print engine, and causes the print engine to start generating the image prior to the secondary paper feed after the primary paper feed.

Further, a computer readable recording medium according to an aspect of the present invention stores an image forming program executed by a computer that controls a print engine to print an image generated from a print job. The print engine performs secondary paper feed after primary paper feed and generates an image based on image data and then transfers and fixes the image on a paper after the secondary paper feed. The image forming program causes the computer to perform the steps of: (a) receiving the print job and causing the print engine to start the primary paper feed, (b) forming the image data based on the received print job and outputting the image data to the print engine and (c) causing the print engine to start generating the image prior to the secondary paper feed after the primary paper feed.

According to the image forming apparatus or the computer readable recording medium according to an aspect of the present invention, a print job receiving unit receives a print job and causes the print engine to start primary paper feed, and a print engine performs the primary paper feed. An image forming unit forms image data based on the print job and outputs the image data to the print engine, and causes the print engine to start generating the image prior to the secondary paper feed after the primary paper feed, and the print engine performs secondary paper feed and generates an image based on image data and then transfers and fixes the image on a paper. Consequently, printing time is reduced in a printer function.

These and other objects, features and advantages of the present invention will become more apparent upon reading of the following detailed description along with the accompanied drawings.

### BRIEF DESCRIPTION OF THE DRAWINGS

FIG. 1 is a block diagram indicating an embodiment of an image forming apparatus according to an aspect of the present invention;

FIG. 2 is a diagram for explaining operation of the image forming apparatus shown in FIG. 1; and

FIG. 3 is a diagram for explaining operation of an ordinary image forming apparatus.

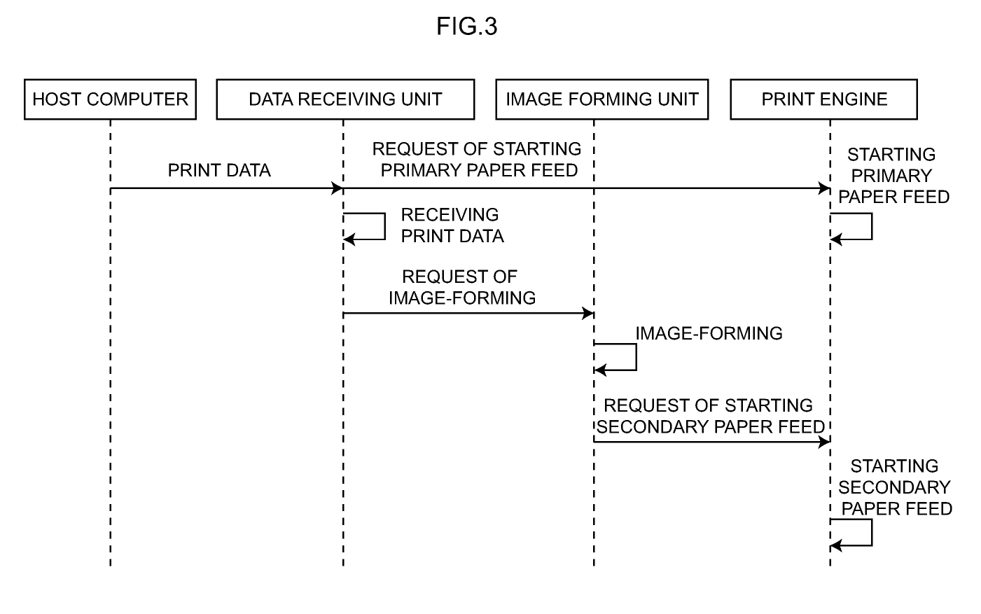

### DETAILED DESCRIPTION OF THE PREFERRED EMBODIMENT

Hereinafter, an embodiment according to an aspect of the present invention will be explained with reference to drawings.

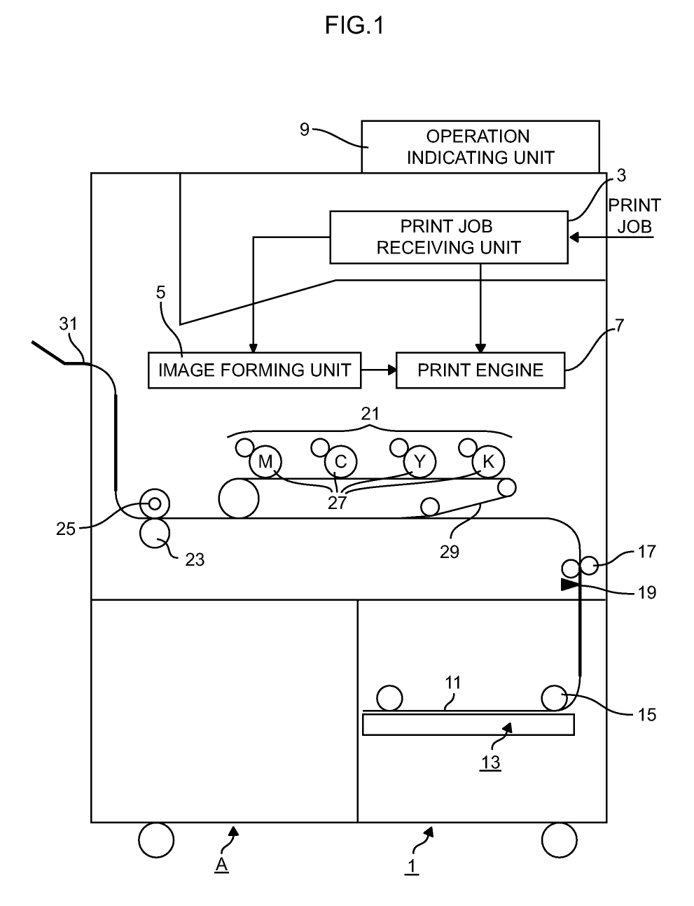

FIG. 1 is a schematic block diagram indicating an image forming apparatus A as an embodiment according to an aspect of the present invention. A computer readable recording medium storing an image forming program as an embodiment according to an aspect of the present invention will be explained in explanation of the image forming apparatus A.

In FIG. 1, a print job receiving unit 3, an image forming unit 5, a print engine 7, an operation indicating unit 9 and other components required to an image forming apparatus such as printer or multi function peripheral are disposed in a body case 1 of the image forming apparatus A.

The print job receiving unit 3 has an input port function for receiving input of a print job from an external computer (not shown) or the like. The print job receiving unit 3 is connected to the image forming unit 5.

The print job receiving unit 3 is also connected to the print engine 7, and has a controlling function for causing the print engine 7 to start primary paper feed, for instance, when the print job receiving unit 3 starts receiving a print job. Alternatively, an instruction of starting primary paper feed may be supplied to the print engine 7 when the print job receiving unit 3 receives the entire print job.

The image forming unit 5 analyzes a print job supplied from the print job receiving unit 3 and forms image data containing, for instance, bitmap image data of each page based on the print job, and then outputs the image data to the print engine 7.

The image forming unit 5 has a controlling function for causing the print engine 7 to start generating an image, as mentioned below. If it is requested to enlarge, reduce and/or rotate an image to be printed, the image forming unit 5 causes the print engine 7 to start generating an image after processing the request.

The print engine 7 has a paper drawer 13 such as paper magazine, a roller 15, a resist roller 17, a resist sensor 19, a color image transferring unit 21, a fixing unit, and electronic circuits and mechanism (not shown) for driving them. In the paper drawer 13, one or more sheets of paper 11 is/are put. The roller 15 performs primary paper feed of the paper 11 from the paper drawer 13. The resist roller 17 controls transportation timing and the position of the paper 11 after the primary paper feed. The resist sensor 19 detects that the paper 11 reaches to the resist roller 17. The fixed unit contains a heat roller 23 and a pressure roller 25 to heat and pressure the paper 11 on which an image has been transferred by the color image transferring unit 21.

It should be noted that for explanation, the paper 1 1, the paper drawer 13, the roller 15, the resist roller 17, the sensor 19, the image transferring unit 21, the heat roller 23 and the pressure roller 25 in the print engine 7 are depicted as other components extracted from the print engine 7 in FIG. 1.

The color image transferring unit 21 has four light emitting units (not shown), four transfer drums 27 and an intermediate transferring unit 29 (such as intermediate transfer belt). The light emitting units emit light such as laser light according to a color image data formed by the image forming unit 5. In each of the transfer drums 27, outer surface is charged and electrostatic latent images of a color image to be printed is generated with the light, and toner images are developed. The intermediate transferring unit 29 generates a transferred image on itself in terms of transferring the toner images developed on the transfer drums 27.

The four transfer drums 27 are disposed in tandem, and correspond to respective primary colors, i.e. CMYK (Cyan, Magenta, Yellow, Key: Black). The four light emitting units are also disposed corresponding to the respective transfer drums 27, and outputs image-generation completion information when the images are generated.

It should be noted that “generating images” in the print engine 7 means generating electrostatic latent images and developing toner images on the transfer drums 27, for instance, according to color image data from the image forming unit 5.

The intermediate transferring unit 29 has a shape like a transportation belt. Primary color toner images on the respective transfer drums 27 are individually transferred on the intermediate transferring unit 29, and consequently a color toner image is generated on the intermediate transferring unit 29 in terms of combining the primary color toner images.

In the print engine 7, upon receiving an instruction of starting primary paper feed, the roller 15 transports the paper 11 from the paper drawer 13 to the resist roller 17 in primary paper feed. Upon receiving an instruction of starting to generate an image, electrostatic latent images are generated and toner images are developed on the transfer drums 27. Image-generation completion information occurs upon being ready to transfer images to the intermediate transferring unit 29. Afterwards, the resist roller 17 performs secondary paper feed of the waiting paper 11, a color image is transferred from the intermediate transferring unit 29 to the paper 11, the color image is fixed by the heat roller 23 and the pressure roller 25, and then the paper 11 is output to an output unit 31.

Functions performed in a part of the image forming unit 5 and the print engine 7 are realized with software (i.e. program control).

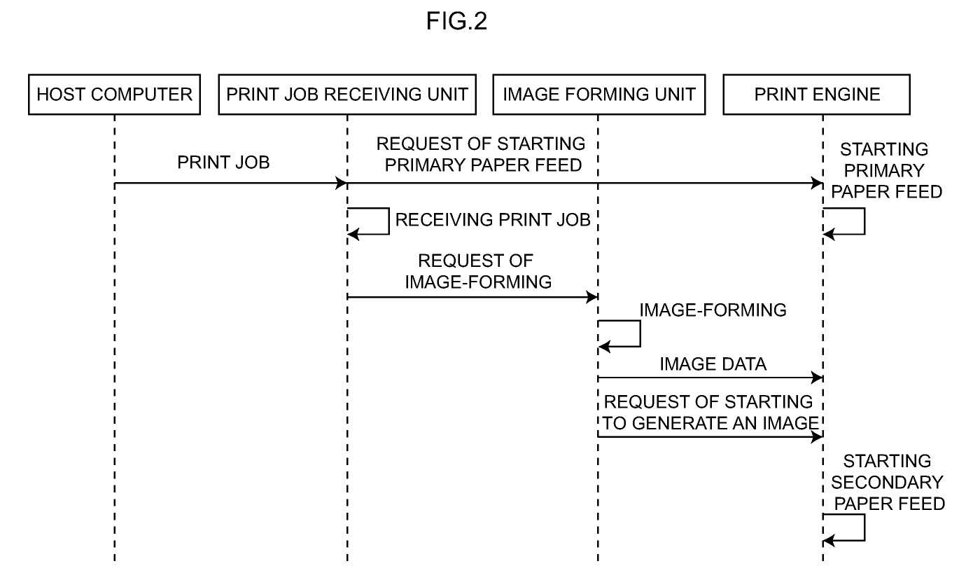

Operation of the aforementioned image forming apparatus will be explained next with reference to FIG. 2.

The print job receiving unit 3 receives a print job transmitted from a host computer and supplies an instruction to the print engine 7 at the beginning of receiving the print job for starting primary paper feed. The print engine 7 starts primary paper feed of the paper 11 upon receiving the instruction. In this way, the image forming apparatus A performs print job receiving process.

Further, the print job receiving unit 3 continues receiving the print job and outputs the print job to the image forming unit 5 to request forming image data after receiving the entire print job.

Upon this, the image forming unit 5 forms image data based on the print job with necessary image processing such as enlargement, reduction or rotation, and supplies the image data to the print engine 7. In this way, the image forming apparatus A performs image forming process.

In addition, the image forming unit 5 supplies a request (an instruction) to the print engine 7 in order to start generating images prior to secondary paper feed after primary paper feed. In this way, the image forming apparatus A performs image generation controlling process.

The print engine 7 generate images on the transfer drums 27 according to the instruction to start generating an image, and transfers the images on the transfer drums 27 onto the intermediate transferring unit 29. According to the image-generation completion information, the print engine 7 controls the resist roller 17 to perform secondary paper feed of the paper 11, transferring an image onto the paper 11, fixing the image on the paper 11, as mentioned above.

As mentioned above, the image forming apparatus of this embodiment contains the print engine 7, the print job receiving unit 3 and the image forming unit 5. The print engine 7 performs secondary paper feed under a predetermined condition after primary paper feed, and generates an image based on image data and then transfers and fixes the image on a paper after the secondary paper feed. If the image is a color image, the image consists of primary color images. The print job receiving unit 3 receives a print job and causes the print engine 7 to start the primary paper feed. The image forming unit 5 forms the image data based on the print job and outputs the image data to the print engine 7, and causes the print engine 7 to start generating the image prior to the secondary paper feed after the primary paper feed.

Therefore, printing time is reduced due to performing primary paper feed in parallel with receiving a print job. Especially, printing time is reduced much more if the primary paper feed is controlled as started at the beginning of receiving the print job. A timing that must occur such as the beginning of receiving the print job can be used for the start timing of the primary paper feed.

Further, in the print engine 7, generating an image is started prior to secondary paper feed and the secondary paper feed can be performed while generating an image. Therefore, even if necessary time to generate an image and transfer the image is not constant, secondary paper feed will be performed with taking the necessary time into account in order to transfer the image onto the paper 11 adequately.

Furthermore, the print engine 7 performs transferring the image and the secondary paper feed after the image forming unit 5 causes the print engine 7 to start generating an image. Therefore, program control for communication between the image forming unit 5 and the print engine 7 is not complicated.

Further, in case that an image transferred onto the intermediate transferring unit 29 is transferred and fixed on the paper 11, especially that a color image is transferred and fixed, time from generating an image to transferring the image tends to be long in the print engine 7. However, in this embodiment, since generating an image in the print engine 7 is started prior to secondary paper feed, printing time is surely reduced.

Especially, in case that the print engine 7 has transfer drums for respective primary colors of a color image and the transfer drums are disposed in tandem, printing time is reduced much more.

It should be noted that a monochrome image transferring unit might be used instead of the color image transferring unit 21.

Further, since the print engine 7 performs secondary paper feed according to the image-generation completion information, printing time is reduced with transferring an image adequately.

Furthermore, in the image forming apparatus of this embodiment, the print job receiving unit 3 may cause to start primary paper feed at the end of receiving a print job. In this case, waiting time of paper from primary paper feed to secondary paper feed tends to be constant without regard to the size of the print job, and therefore, printing time is reduced with printing adequately. In addition, the print job receiving unit 3 may cause to start primary paper feed at the beginning of receiving a print job. In this case, printing time is generally reduced much more.

The image forming apparatus of this embodiment can be applied to a printer, a copier, a facsimile machine or a multi function peripheral as a combination of them, or other various type of printing device, specially, is favorable to a printer that handles various sizes of print jobs.

The image forming apparatus of this embodiment may contain a computer that controls the print engine 7 to print an image generated from a print job on a paper. The print engine 7 performs secondary paper feed after primary paper feed and generates an image based on image data and then transfers and fixes the image on a paper after the secondary paper feed. According to an image forming program, the computer performs the steps of: (a) receiving the print job and causing the print engine 7 to start the primary paper feed, (b) forming the image data based on the received print job and outputting the image data to the print engine 7 and (c) causing the print engine 7 to start generating the image prior to the secondary paper feed after the primary paper feed. The image forming program is stored in a computer readable recording medium such as ROM, hard disk drive, flexible disk, memory card or optical/magnetic disk, and is provided with the medium. The image forming program is read out from the medium to the computer, and causes to supply instructions to components in the image forming apparatus in order to cause the components to perform respective processes.

In view of the embodiment described above, some aspects of the present invention are summarized as follows. An image forming apparatus according to an aspect of the present invention includes (a) a print engine that performs secondary paper feed after primary paper feed, and generates an image based on image data and then transfers and fixes the image on a paper after the secondary paper feed, (b) a print job receiving unit that receives a print job and causes the print engine to start the primary paper feed and (c) an image forming unit that forms the image data based on the print job and outputs the image data to the print engine, and causes the print engine to start generating the image prior to the secondary paper feed after the primary paper feed.

In the image forming apparatus according to an aspect of the present invention, the print engine may transfer and fix the image transferred on an intermediate transfer unit onto a paper.

In the image forming apparatus according to an aspect of the present invention, the print engine may generate a color image based on image data and then transfer and fix the color image on the paper.

In the image forming apparatus according to an aspect of the present invention, the print engine may have transfer drums disposed in tandem for respective colors used in the color image, and the image forming unit may cause the print engine to start generating the color image that consists of images with respective colors on the transfer drums.

In the image forming apparatus according to an aspect of the present invention, the print engine may perform the secondary paper feed according to image-generation completion information.

In the image forming apparatus according to an aspect of the present invention, the print job receiving unit may cause the print engine to start the primary paper feed when the print job receiving unit starts receiving a print job.

In the image forming apparatus according to an aspect of the present invention, the print job receiving unit may cause the print engine to start the primary paper feed when the print job receiving unit ends receiving a print job.

A computer readable recording medium according to an aspect of the present invention stores an image forming program executed by a computer that controls a print engine to print an image generated from a print job on a paper. The print engine performs secondary paper feed after primary paper feed and generates an image based on image data and then transfers and fixes the image on a paper after the secondary paper feed. The image forming program causes the computer to perform the steps of: (a) receiving the print job and causing the print engine to start the primary paper feed, (b) forming the image data based on the received print job and outputting the image data to the print engine and (c) causing the print engine to start generating the image prior to the secondary paper feed after the primary paper feed.

According to the image forming apparatus or the computer readable recording medium according to an aspect of the present invention, printing time is reduced in a printer function.

Further, in case that an image transferred onto the intermediate transferring unit is transferred and fixed on a paper, printing time is surely reduced.

Further, in case that a color image is transferred and fixed, time from generating an image to transferring the image tends to be long in the print engine, and consequently, printing time tends to be reduced.

Further, in case that the print engine has transfer drums for respective primary colors of a color image and the transfer drums are disposed in tandem, and the image forming unit causes to start generating primary color images on the transfer drums, time from generating an image to transferring the image tends to be long in the print engine, and consequently, printing time tends to be reduced.

Furthermore, in case that the print engine performs secondary paper feed according to the image-generation completion information, printing time is reduced with transferring an image adequately.

Further, in case that the print job receiving unit causes to start primary paper feed at the beginning of receiving a print job, printing time is reduced much more.

Furthermore, in case that the print job receiving unit causes to start primary paper feed at the end of receiving a print job, printing time is also reduced much more.

What is claimed is:

1. An image forming apparatus comprising:
a print engine that performs secondary paper feed after primary paper feed, and generates an image based on image data and then transfers and fixes the image on a paper after the secondary paper feed;
a print job receiving unit that receives a print job and causes the print engine to start the primary paper feed; and
an image forming unit that forms the image data based on the print job and outputs the image data to the print engine, and causes the print engine to start generating the image prior to the secondary paper feed after the primary paper feed.

2. The image forming apparatus according to claim 1, wherein the print engine transfers and fixes the image transferred on an intermediate transfer unit onto the paper.

3. The image forming apparatus according to claim 1, wherein the print engine generates a color image based on image data and then transfers and fixes the color image on the paper.

4. The image forming apparatus according to claim 3, wherein the print engine has transfer drums disposed in tandem for respective colors used in the color image, and the image forming unit causes the print engine to start generating the color image that consists of images with the respective colors on the respective transfer drums.

5. The image forming apparatus according to claim 1, wherein the print engine performs the secondary paper feed according to image-generation completion information.

6. The image forming apparatus according to claim 1, wherein the print job receiving unit causes the print engine to start the primary paper feed when the print job receiving unit starts receiving a print job.

7. The image forming apparatus according to claim 1, wherein the print job receiving unit causes the print engine to start the primary paper feed when the print job receiving unit ends receiving a print job.

8. A computer readable recording medium storing an image forming program executed by a computer that controls a print engine to print an image generated from a print job, the print engine performing secondary paper feed after primary paper feed and generating an image based on image data and then transferring and fixing the image on a paper after the secondary paper feed, the image forming program causing the computer to perform the steps of:
receiving the print job and causing the print engine to start the primary paper feed;
forming the image data based on the received print job and outputting the image data to the print engine; and
causing the print engine to start generating the image prior to the secondary paper feed after the primary paper feed.
